(19) United States
(12) Patent Application Publication
(10) Pub. No.: US 2007/0114821 A1
(43) Pub. Date: May 24, 2007

(54) Forward position bicycle passenger seat

(76) Inventors: Gabriel R. Sosa III, Panama City (PA); John A. Scialdone, Diamondhead, MS (US)

Correspondence Address: DICKINSON WRIGHT PLLC, 1901 L. STREET NW, SUITE 800, WASHINGTON, DC, 20036, US

(21) Appl. No.: 11/649,903

(22) Filed: Jan. 5, 2007

Related U.S. Application Data
(63) Continuation-in-part of application No. 11/159,071, filed on Dec. 20, 2004, now abandoned.

(51) Int. Cl. B62J 1/00

(52) U.S. Cl. 297/195.13

(57) ABSTRACT

A passenger bicycle seat assembly (20) includes a box plate (30) that secures the assembly (20) to the bicycle (28). A position locking device (44) extends from the bottom of the box plate (30) and engages the frame (26) of the bicycle (28) and prevents movement of the assembly (20) from side to side. The box plate (30) defines a hole (54) that extends through the box plate (30). The hole (54) is disposed adjacent to the rear end (34) of the box plate (30) and secures the box plate (30) to the bicycle (28). The hole (54) encloses and fits the mounting shaft (24) that extends between the operator seat (22) and the frame (26) to prevent movement side to side and forward and backward along the frame (26).

### CROSS REFERENCE TO RELATED APPLICATION

This application is a continuation-in-part of application Ser. No. 11/159,071 filed Dec. 20, 2004. This application claims the benefit of the earlier field application and contains no new matter.

### BACKGROUND OF THE INVENTION

1. Field of the Invention

The subject invention relates to a passenger bicycle seat assembly for seating a passenger in front of an operator seat and mounting shaft and for supporting the passenger on a frame of a bicycle.

2. Description of the Prior Art

Numerous methods exist to provide a secondary seat on a bicycle for a passenger. The art is rich with assemblies that place the passenger seat in various locations on the bicycle. These locations include on or in front of a handle bar, behind a operator seat and operator seat mounting shaft, and between the operator seat and handle bar.

Many of the passenger bicycle seat assemblies located between the operator seat and handle bar include a box plate or mounting arrangement having a front end and a rear end for securing the assembly to the bicycle. The passenger seat is mounted adjacent the front end of the box plate for the passenger to sit on. A position locking device extends from the bottom of the box plate for engaging the frame of the bicycle and preventing movement of the assembly from side to side.

An example of such a passenger seat assembly is disclosed in U.S. Pat. No. 4,919,479 (the '479 patent) to Loewke et al.

The '479 patent discloses an assembly that includes a mounting arrangement having a passenger seat located intermediate the front and rear ends. The assembly includes a position locking device or bracket that extends from the bottom of the assembly and connects the assembly to the frame of the bicycle. This bracket is fastened to secure the assembly to the frame and prevent side to side and forward and backward movement of the assembly. The '479 patent discloses a recess defined by two forks that engage the mounting shaft of the operator seat. The mounting shaft sits in the recess and prevents side to side movement, but only limits the forward and backward movement of the assembly. The forward and backward movement is controlled by the bracket fastened to the frame.

Although the prior art places the passenger seat between the operator seat and handle bar of the bicycle by securing the assembly to the frame of the bicycle, there is a continuing need for assemblies having more efficient or alternative configurations.

### SUMMARY OF THE INVENTION AND ADVANTAGES

The subject invention provides for a box plate that defines a hole that extends through the box plate and is disposed adjacent to the rear end. The hole secures the box plate and assembly to the bicycle by enclosing and fitting the mounting shaft that extends between the operator seat and the frame of the bicycle. This hole prevents movement from both side to side and forward and backward along the frame. The mounting shaft passes through the hole, so as to lock the passenger bicycle seat assembly into position.

Accordingly, the invention is easy to install and requires minimal assembly. To utilize the present invention one must remove the operator seat and connected mounting shaft from the frame of the bicycle, place the passenger bicycle seat assembly in the proper position, and insert the mounting shaft through the hole in the box plate and back into engagement with the bicycle frame.

### BRIEF DESCRIPTION OF THE DRAWINGS

Other advantages of the present invention will be readily appreciated, as the same becomes better understood by reference to the following detailed description when considered in connection with the accompanying drawings wherein:

FIG. 1 is a fragmented perspective view of a bicycle embodying the subject invention;

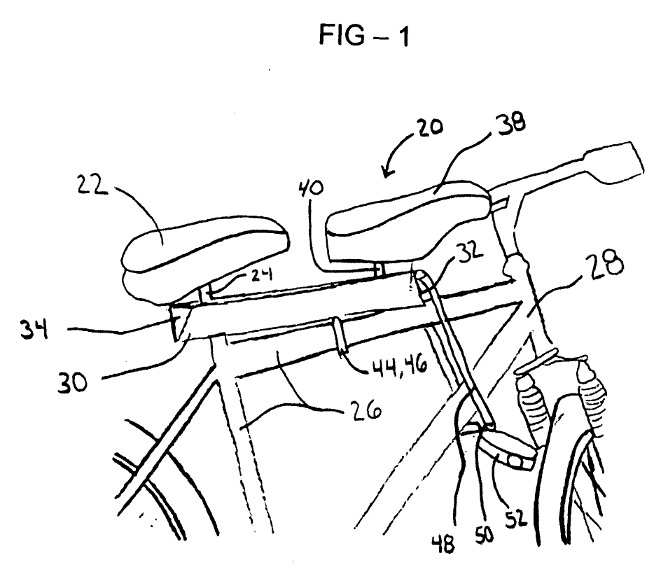

FIG. 2 is a perspective view of the subject invention;

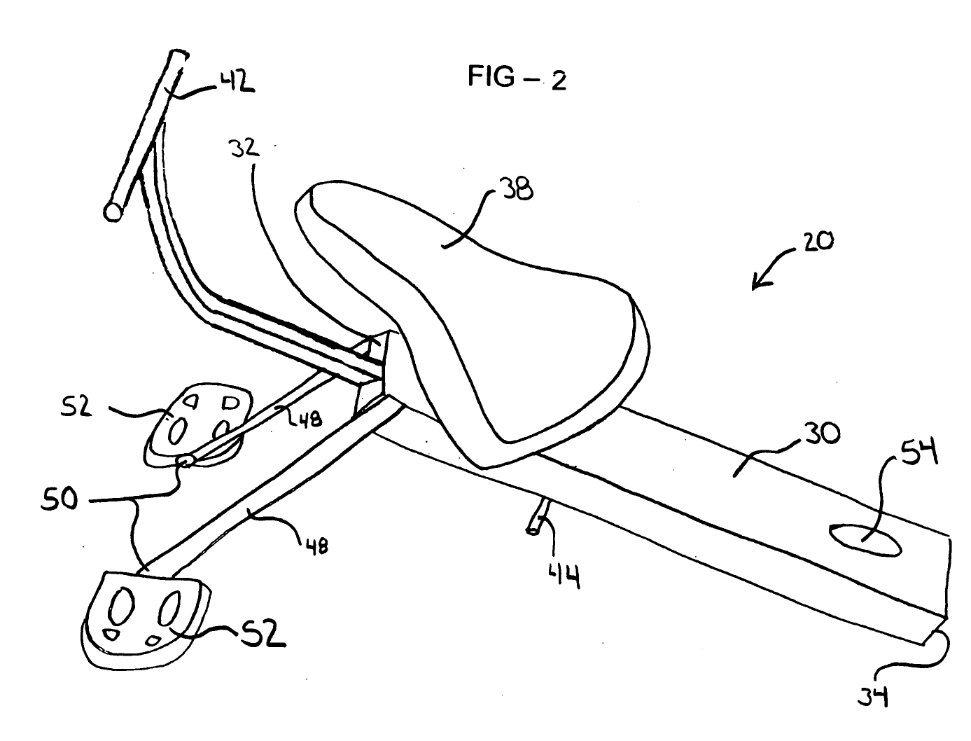

FIG. 3 is an exploded view of the subject invention;

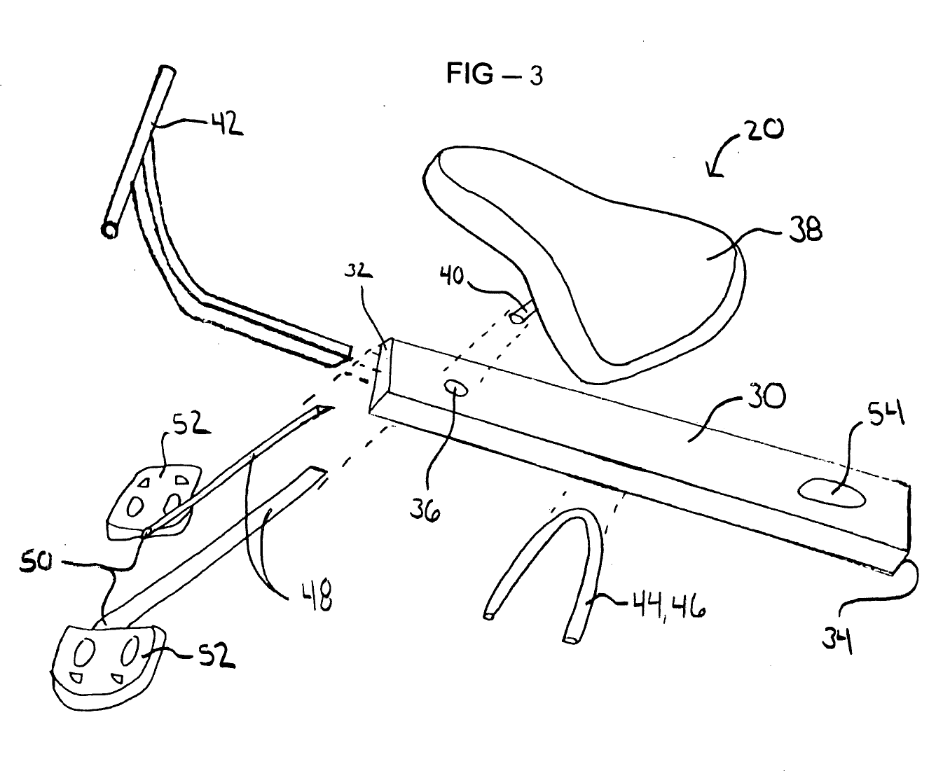

FIG. 4 is a perspective view of a box plate utilized in the subject invention;

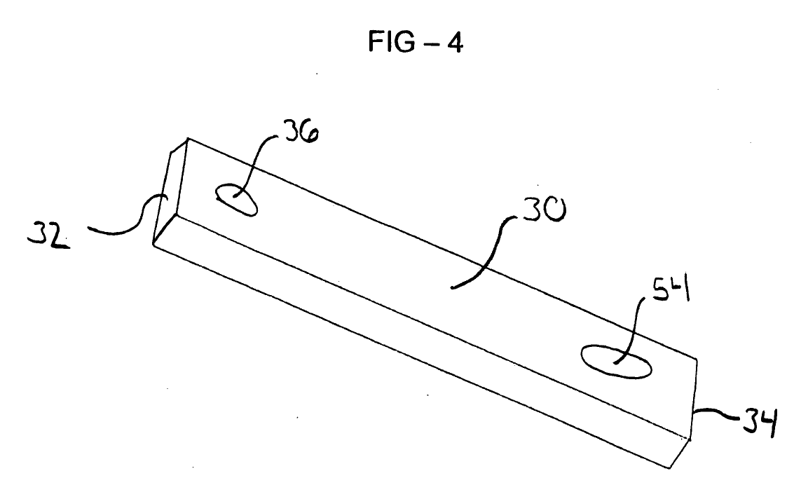

FIG. 5 is a perspective view of pipes and pedals utilized in the subject invention;

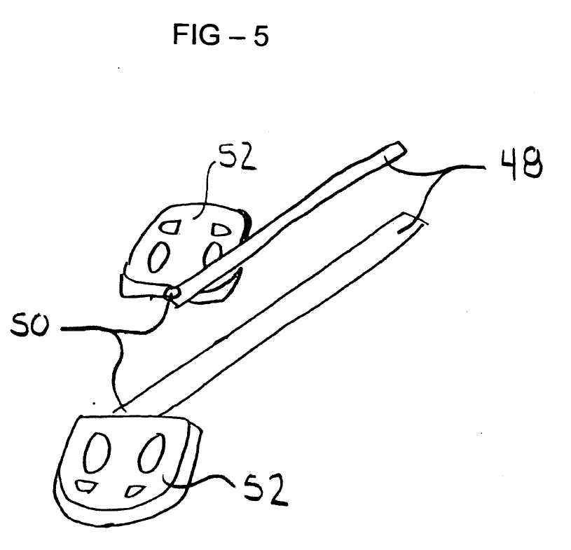

FIG. 6 is a perspective view of a handle bar utilized in the subject invention;

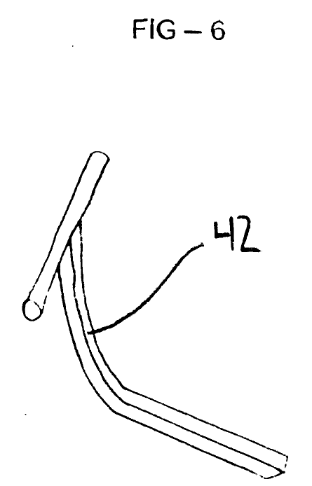

FIG. 7 is a perspective view of a passenger seat utilized in the subject invention; and

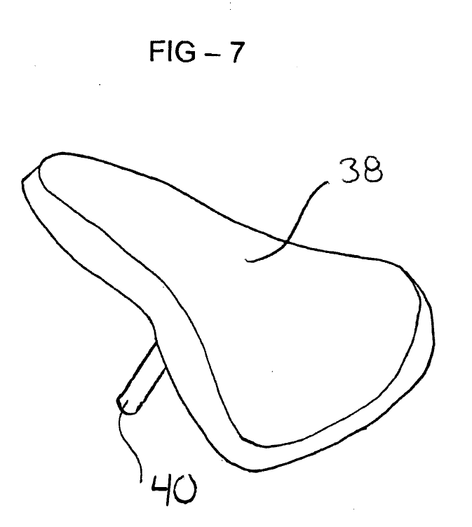

FIG. 8 is a perspective view of a U-pin utilized in the subject invention.

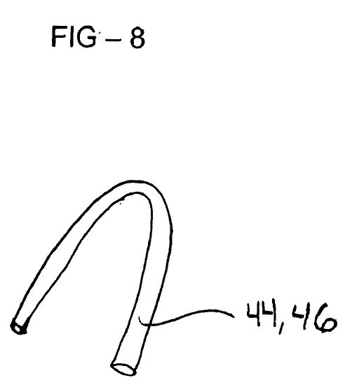

### DETAILED DESCRIPTION OF THE INVENTION

Referring to the Figures, wherein like numerals indicate corresponding parts throughout the several views, a passenger bicycle seat assembly 20 is generally shown for seating a passenger in front of an operator seat 22 and mounting shaft 24 and for supporting the passenger on a frame 26 of a bicycle 28.

The subject invention comprises a box plate 30 that secures the assembly 20 to the bicycle 28. The box plate 30 includes a front end 32 and a rear end 34. The box plate 30 is typically made of metal, but may be any material known in the art. The box plate 30 is rectangular in cross section, but may be any shape known in the art. A typical box plate 30 may be 17 inches in length, 4 inches in width, and 2 inches in depth. The box plate 30 defines a circular opening 36 that is disposed adjacent the front end 32.

The assembly 20 includes a passenger seat 38 for the passenger to sit on. A shaft 40 extends from the bottom of the passenger seat 38 and engages the opening 36 to secure the shaft 40 of the passenger seat 38 in the opening 36 of the box plate 30.

The assembly 20 includes a handle bar 42 or T bar that extends from the front end 32 of the box plate 30. The handle bar 42 supports the passenger by giving the passenger a place to put their hands.

A position locking device 44 extends from the bottom of the box plate 30. Typically the position locking device 44 is located behind the passenger seat 38 on the bottom of the box plate 30. The position locking device 44 engages the frame 26 of the bicycle 28 and prevents movement of the assembly 20 from side to side. The position locking device 44 may be a U-pin 46 that straddles the frame 26 of the bicycle 28 and prevents movement of the assembly 20 from side to side. The position locking device 44 may be a pair of bolts, such as 2 inch bolts, with the bolts being spaced from one another to straddle the frame 26 of the bicycle 28 and prevent movement of the assembly 20 from side to side.

The assembly 20 includes at least one metal pipe 48 having an end 50 that extends away from the passenger seat 38 and down from the front end 32 of the box plate 30 to the end 50. The pipes 48 sit at 90 degrees from the passenger seat 38 and box plate 30 and are typically 9 inches in length. A pedal 52 is mounted to the end 50 of the pipe 48 to allow the passenger a place to put their feet. The pedals 52 are stationary and are typically 4 inch pedals 52.

The assembly 20 is distinguished by the box plate 30 defining a hole 54 that extends through the box plate 30. The hole 54 is disposed adjacent to the rear end 34 of the box plate 30 and secures the box plate 30 to the bicycle 28. The hole 54 encloses and fits the mounting shaft 24 that extends between the operator seat 22 and the frame 26 to prevent from movement side to side and forward and backward along the frame 26. The hole 54 can be any shape that encloses the mounting shaft 24 such as, a 2 inch by 1.5 inch ellipse. The mounting shaft 24 passes through the hole 54, so as to lock the passenger bicycle seat assembly 20 into position along the frame 26 of the bicycle 28 at a location forward of the operator seat 22.

The assembly 20 is easy to install. To utilize the present invention one must remove the operator seat 22 and connected mounting shaft 24 from the frame 26 of the bicycle 28, place the passenger seat 38 assembly 20 in the proper position, and insert the mounting shaft 24 through the hole 54 in the box plate 30 and back into engagement with the bicycle 28 frame 26.

Obviously, many modifications and variations of the present invention are possible in light of the above teachings and may be practiced otherwise than as specifically described while within the scope of the appended claims. The use of the word “said” in the apparatus claims refers to an antecedent that is a positive recitation meant to be included in the coverage of the claims whereas the word “the” precedes a word not meant to be included in the coverage of the claims.

ELEMENT LIST

| Element Symbol | Element Name |
|---|---|
| 20 | passenger bicycle seat assembly |
| 22 | operator seat |
| 24 | mounting shaft |
| 26 | frame |
| 28 | bicycle |
| 30 | box plate |
| 32 | front end |
| 34 | rear end |
| 36 | opening |
| 38 | passenger seat |
| 40 | shaft |
| 42 | handle bar |
| 44 | position locking device |
| 46 | U-pin |
| 48 | pipe |
| 50 | end |
| 52 | pedal |
| 54 | hole |

What is claimed is:

1. A passenger bicycle seat assembly for seating a passenger in front of an operator seat and mounting shaft and for supporting the passenger on a frame of a bicycle and comprising;
a box plate having a front end and a rear end for securing said assembly to the bicycle,
a passenger seat mounted adjacent said front end of said box plate for the passenger to sit on,
a position locking device extending from the bottom of said box plate for engaging the frame of the bicycle and preventing movement of said assembly from side to side, and
said box plate defining a hole extending through said box plate and disposed adjacent to said rear end for securing said box plate to the bicycle by said hole enclosing and fitting the mounting shaft extending between the operator seat and the frame to prevent movement side to side and forward and backward along the frame.

2. An assembly as set forth in claim 1 including at least one metal pipe having an end and extending away from said passenger seat and down from said front end of said box plate to said end, and including a pedal being stationary and mounted to said end of said pipe for placing the feet of the passenger.

3. An assembly as set forth in claim 2 including a handle bar extending from said front end of said box plate for placing the hands of the passenger and supporting the passenger.

4. An assembly as set forth in claim 3 wherein said box plate defines a circular opening disposed adjacent said front end and said passenger seat includes a shaft extending from the bottom of said passenger seat to engage said opening for securing said passenger seat in said opening of said box plate.

5. An assembly as set forth in claim 4 wherein said position locking device is a U-pin for straddling the frame of the bicycle and preventing movement of said assembly from side to side.

6. An assembly as set forth in claim 5 wherein said box plate is metal and rectangular in cross section.

7. A passenger bicycle seat assembly for seating a passenger in front of an operator seat and mounting shaft and for supporting the passenger on a frame of a bicycle and comprising;
a box plate of metal being rectangular in cross section for securing said assembly to the bicycle and said box plate having a front end and a rear end,
said box plate defining a circular opening disposed adjacent said front end,
a passenger seat for the passenger to sit on,
a shaft extending from the bottom of said passenger seat and engaging said opening for securing said passenger seat in said opening of said box plate,
a handle bar extending from said front end of said box plate for placing the hands of the passenger and supporting the passenger,
a position locking device extending from the bottom of said box plate for engaging the frame of the bicycle and preventing movement of said assembly from side to side,
at least one metal pipe having an end and extending away from said passenger seat and down from said front end of said box plate to said end,
a pedal being stationary and mounted to said end of said pipe for placing the feet of the passenger, and
said box plate defining a hole extending through said box plate and disposed adjacent to said rear end for securing said box plate to the bicycle by said hole enclosing and fitting the mounting shaft extending between the operator seat and the frame to prevent movement side to side and forward and backward along the frame.

8. An assembly as set forth in claim 7 wherein said position locking device is a U-pin for straddling the frame of the bicycle and preventing movement of said assembly from side to side.
